(19) United States
(12) Patent Application Publication
(10) Pub. No.: US 2004/0216283 A1
(43) Pub. Date: Nov. 4, 2004

(54) Clip

(76) Inventor: Terry Cassaday, Toronto (CA)

Correspondence Address: MILLER THOMPSON, LLP, 20 QUEEN STREET WEST, SUITE 2500, TORONTO, ON, M5H 3S1, CA

(21) Appl. No.: 10/428,080

(22) Filed: May 2, 2003

(51) Int. Cl. B42F 1/00

(52) U.S. Cl. 24/67.5; 24/328

(57) ABSTRACT

A clip for securing sheet material comprising a base; a cam member operably connected to said base for displaceable movement between; an open position for insertion of said sheet material between said base and said cam member; a closed position for gripping said sheet material between said base and said cam.

### FIELD OF INVENTION

This invention relates to a clip for securing sheet material having a base and a rotatably movable cam member; and particularly relates to paper clips for securing paper between first and second opposed surfaces and a displaceable cam member, and includes the method of clamping said paper therebetween.

### BACKGROUND ART

There have been a variety of fastening devices for fastening, clamping, or gripping substantially flat articles such as sheet material or the like. Such fastening devices can include clipboards, staples, paper clips and the like for holding, fastening or clamping a plurality of sheets, fabric, paper or other material.

In particular it is well known to employ staples as well as paper clips to hold sheets of paper together such as the standard metal oblong-shaped paper clip or the metallic clamping paper clip having two pressure bearing legs that must be separated to insert paper there between. Such metal paper clips and staples can damage paper.

Moreover a piece of paper can inadvertently get snagged in the prior art oblong-shaped paper clip which is attached to other papers and thereby be incorrectly filed.

Furthermore many paper clips do not get used as paper clips particularly the wire paper clips which often get extended to clean articles or bent out of shape in a mechanical form of doodling.

These and other prior art devices such as the spring wire clip formed from spring steel wire having a triangular head with a pair of forwardly and inwardly extending legs have been disclosed in U.S. Pat. No. 4,299,013.

Moreover U.S. Pat. No. 4,440,374 relates to a resilient clip for supporting elongated articles where a base has an integrally formed flexible arm.

Another arrangement is shown in U.S. Pat. No. 5,056,197 which relates to a clip of extruded plastic material.

Yet other plastics clips are disclosed in U.S. Pat. No. 5,400,483 while U.S. Pat. No. 5,479,682 relates to a clamp comprising a U-shaped body having a web and two legs for clamping paper sheets.

Other clip arrangements are shown in U.S. Pat. No. 6,260,244 which relates to a plastic clip; U.S. Pat. No. 6,163,934 which illustrates a multi-purpose paper clip; U.S. Pat. No. 6,018,850 which shows a clip for sheets of paper, and U.S. Pat. No. 5,214,825 which illustrates a paper clip with multiple panels.

Clips have also been used to bind paper together as shown in U.S. Pat. Nos. 5,758,902, 5,542,708, 5,626,432, 4,174,910 and 5,320,456.

It is an object of this invention to provide an improved paper clip which is easy to manufacture and use.

### DISCLOSURE OF INVENTION

It is an aspect of this invention to provide a clip for securing sheet material comprising a base; a cam member operably connected to said base for displaceable movement between; an open position for insertion of said sheet material between said base and said cam member; a closed position for gripping said sheet material between said base and said cam.

It is another aspect of this invention to provide a paper clip for securing paper comprising first and second opposed surfaces, each having a forward and rear edge, and connected together at said rear edge, to permit insertion of said paper through said front edge between said first and second surfaces; a cam member pivotally connected to said front edge of said second surface for displaceable movement between; an open position where said cam member is displaced away from said first surface to permit insertion of said paper between said first and second surfaces, and a closed position where said cam member is displaced towards said first member to clamp said paper between said cam member and said second surface.

It is yet a further aspect of this invention to provide a method of clamping paper in a paper clip having spaced first and second opposed surfaces, each first and second opposed surface having a forward and rear edge, and connected together at said rear edge, and a cam member having a tab at one end thereof and a cam surface at another end thereof comprising the steps of moving said tab to a first open position where said cam surface is displaced away from said first surface; inserting paper through said forward edge between the said first and second opposed surfaces; moving said tab to a closed position whereby said cam surface is displaced towards said first surface to clamp said paper between said cam surface and said second opposed surface.

### BRIEF DESCRIPTION OF DRAWINGS

FIG. 1 is a perspective view of one embodiment of the paper clip in a closed position.

FIG. 1a is a side elevational view of FIG. 1.

FIG. 2 is a perspective view of the base or housing.

FIG. 3 is a perspective view of the cam member.

FIG. 4 is a top plan view of the paper clip in a closed position.

FIG. 5 is a perspective view of one embodiment of the paper clip in an open position.

FIG. 6 is a perspective view of a paper clip in a closed position.

FIG. 7 is a side elevational view of the paper clip in a closed position.

FIG. 8 is a detailed side view of one embodiment of the paper clip.

FIG. 9 is a perspective view of another embodiment of the invention illustrating a rod between the arms of the paper clip.

FIG. 10 is a perspective view of the second embodiment of the invention in a closed position.

FIG. 11 is a perspective view of the cam member of FIG. 10.

FIG. 12 is a perspective view of a third embodiment of the invention in a closed position.

FIG. 13 is a top plan view of FIG. 12.

FIG. 14 is a side elevational view of FIG. 12.

FIG. 15 is a side elevational view of FIG. 12 in a closed position.

FIG. 16. is a side elevational view of FIG. 12 in an open position.

FIG. 17 is a perspective view of the embodiment shown in FIG. 12 with the paper inserted therein.

FIG. 18 is a perspective view of another embodiment of the invention in a closed position.

FIG. 19 is a perspective view of the embodiment illustrated in FIG. 18 in an open position.

FIG. 20 is another perspective view of the embodiment shown in FIG. 19.

FIG. 21 is a side elevational view showing a first cam surface.

FIG. 22 is a side elevational view showing a second cam surface.

FIG. 23 is a top plan view illustrating the use of the invention as a clip board.

FIG. 24a is a side elevational view showing that the base 4 is comprised of magnetic material for use as a fridge magnet capable of clipping sheets of material.

FIG. 24b is a side elevational view where the base includes a pin for use of the device as a pin holder.

FIG. 25 is a top plan view showing the use of the invention as a binding system.

FIG. 26 is a top plan view showing the use of the invention as a tab for a file folder.

FIG. 27 is a perspective view showing the clamp being used to temporarily close an open bag.

FIG. 28 is a perspective view of the clip adapted to clip the corner of a stack of paper.

FIG. 29 is a perspective view of a plurality of clips carried by a frame to hold either one article or bag or a plurality of articles or bags respectively.

FIG. 30 is a top plan view showing the clip used as a clipboard.

FIG. 31 is a top perspective view illustrating a paper binder.

FIG. 32 is a bottom perspective view of FIG. 31.

FIG. 33 is a cross sectional view taken along 34-34 of FIG. 32 in the closed position.

FIG. 34 is a cross sectional view taken along 34-34 of FIG. 32 in the closed position.

### BEST MODE FOR CARRYING OUT THE INVENTION

In the description which follows, like parts are marked throughout the specification and the drawings with the same respective reference numerals. The drawings are not necessarily to scale and in some instances proportions may have been exaggerated in order to more clearly depict certain features of the invention.

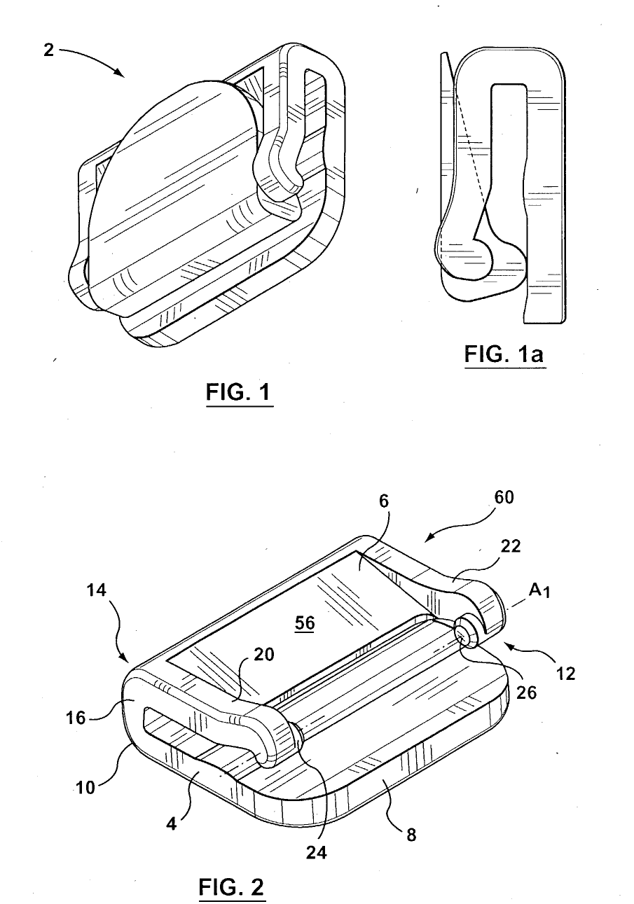

FIGS. 1, 1a, 2 and 3 illustrate one embodiment of the invention which comprises a clip 2 for securing sheet material 40 together. In particular the paper clip 2 has opposed first 4 and second 6 spaced surfaces. The first surface 4 has a forward edge 8 and a rear edge 10 while the second opposed surface 6 also has a forward edge 12 and a rear edge 14. The rear edges 10 and 14 of first and second opposed surfaces 4 and 6 respectively are connected together by a connecting member 16 so as to permit insertion of paper 40 through the forward edges 8 and 12 between the first and second surfaces 4 and 6 respectively.

The first opposed surface 4 also defines a base which extends upwardly through the connecting member 16 and merge with the second surface 6. The second surface 6 includes spaced arms 20 and 22. In particular the spaced arms 20 and 22 are carried by the second surface 6 as best illustrated in FIG. 2. In this way the base 6 extends upwardly to present two spaced apart arms 20 and 22.

The first surface or base 4 is substantially flat as shown.

The spaced arms 20 and 22 each present posts 24 and 26 which are axially aligned along axis A₁ and extend for a short distance between the arms 20 and 22.

The second surface 6 includes a cam member 30.

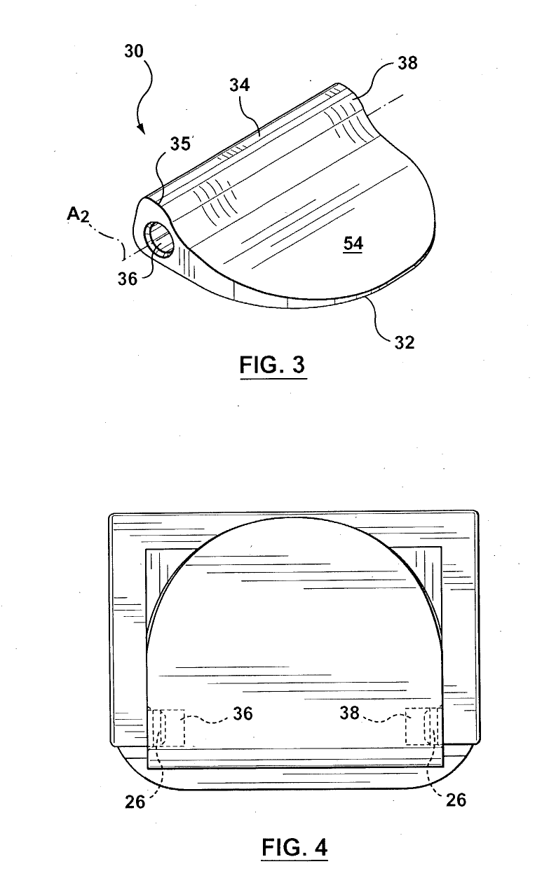

The cam member 30 is generally illustrated in FIG. 3 and consists at one end thereof a tab member 32 which is operably movable as described herein and furthermore the cam member 30 also includes a cam portion 34 which comprises of an enlarged portion at another end of the cam member 30 as best illustrated in FIG. 3. The enlarged or cam portion 34 also includes two opposed holes 36 and 38 which are axially aligned along axis A₂ and adapted to receive the posts 24 and 26 respectively.

The paper clip 2 can be comprised of a variety of materials and in one embodiment consists of suitable plastic which will permit the arms 20 and 22 to flexibly spread apart to accommodate the insertion of the cam member 30 between the arms 20 and 22 and the registration of the posts 24 and 26 within the holes 36 and 38 respectively; for rotational displacement or movement of the cam member 30 relative arms 20 and 22.

As can be seen from FIGS. 2 and 3 the posts 24 and 26 are suitably chamfered as well as the holes 36 and 38 to permit the easy insertion of the cam member 30 so that the axis A₁ of the posts 24 and 26 co-axially align with the axis A₂ of holes 36 and 38.

FIG. 4 is a top plan view of the paper clip 2 in a closed position showing the assembly of the cam member 30 relative the arms 20 and 22. In particular one can see the insertion of the posts 24 and 26 within the holes 36 and 38 respectively. Moreover FIG. 1a illustrates that in the closed position the cam portion 34 contacts the base 4 so as to exert the optimum force there between and grip the paper In other words there is no gap. However the benefits of the invention may still be realized if there was a space or gap between the cam portion 34 and base 4 in the closed position particularly if one desired to clip a large stack of paper.

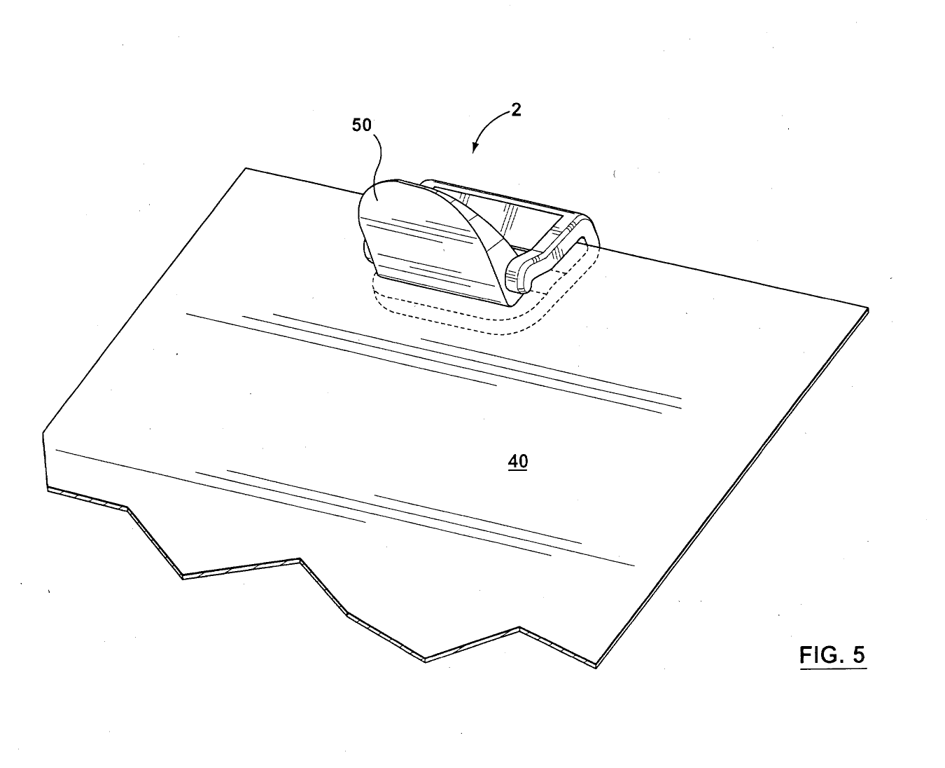

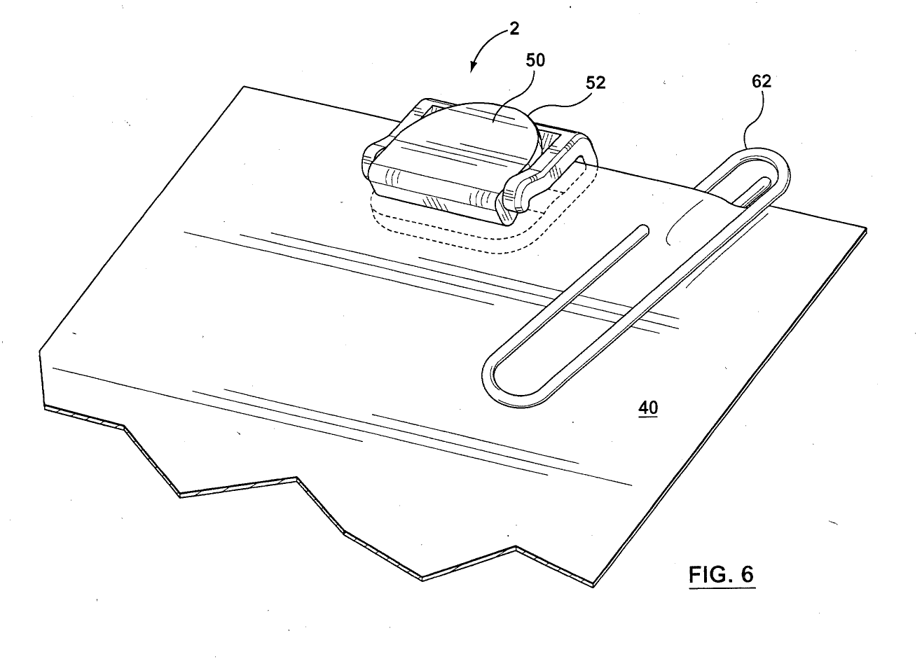

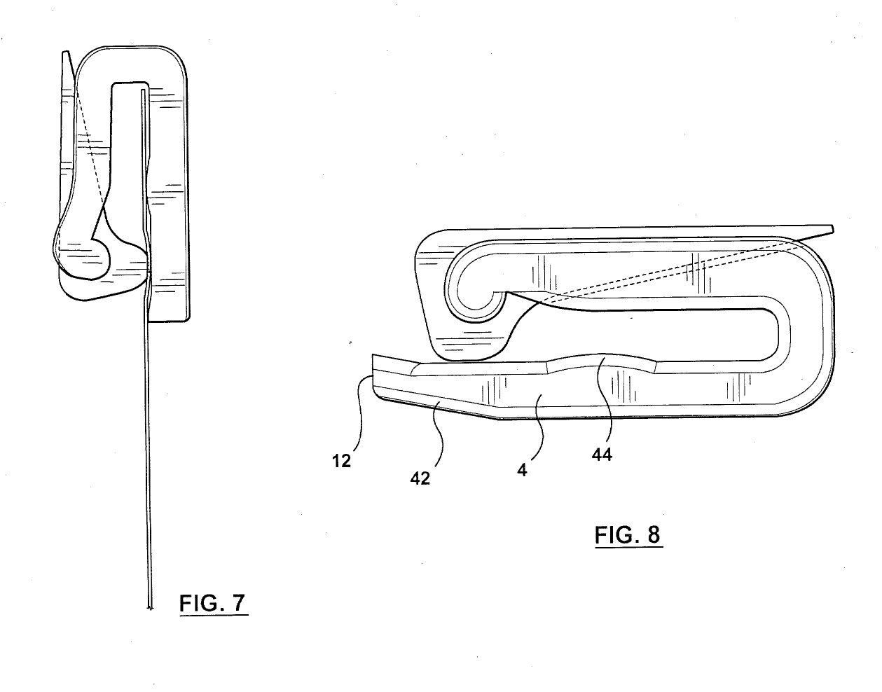

The tab member 30 is adapted for displaceable movement about axis A (which comprises the co-axial superimposition of A₁ and A₂) relative the base 4 as well as the first and second opposed surfaces 4 and 6 from an open position as shown in FIG. 5 to a closed position as shown in FIGS. 6 and 7.

As can be seen from a detailed side elevational view of FIG. 8 the base or first surface 4 includes an upturned forward edge 12 for inhibiting the accidental insertion of paper 40 once the paper clip is in its closed position. The upturned forward edge 12 blocks entry of paper into the cavity defined by first and second surfaces and connecting member 16, when the paper clip 2 is in the closed position.

Furthermore the bottom surface 42 of the upturned front edge 12 of the first surface 4 defines an angled surface for diverting paper 40 away from the clip 2.

The lower surface or base 4 includes a raised portion 44 between the forward edge 8 and rear edge 10 of the base 4 to bend the paper 40 within the cavity so as to assist trapping the paper 40 in the closed position.

A tab member 32 presents a first or top surface 50 as shown in FIG. 6 which may be substantially flat so as to permit the placement of indicia such as the instruction on the use of the paper clip or other advertising material such as a company logo or the like. The tab 32 may be suitably dimensioned as shown in FIG. 6 so as to present a curved edge 52 which extends slightly beyond the rear edge 14 of second surface 6 so as to easily permit a user to push or pull the tab 32 from the closed position shown in FIG. 6 to the open position shown in FIG. 5.

Moreover the lower surface 54 of the tab 32 may be shaped or sculpted to present a gradually diminishing thickness from the holes 36 to the edge 52 so that the tab 32 may be nestled into an appropriately shaped recess 56 presented by the top surface of the second opposing surface 6 to accommodate the reception of the tab 32 in the closed position, so as to present a compact configuration.

The cam member 30 includes an enlarged cam portion 34 which presents a desired side profile 35 to permit the cam surface 34 to be pushed into contact with the paper 40 inserted between the surfaces 4 and 6 in a closed position; as well as permitting a cam surface 34 to be moved away or displaced away from the first surface 4 to permit insertion of the paper between the first and second surfaces 4 and 6; or alternatively to permit a user to withdraw paper 40 placed between the first and second surfaces 4 and 6 respectively.

The spaced opposed surfaces 4 and 6 generally define a housing or frame structure 60 which is operably connected to the displaceable cam member 30.

The paper clip 2 can be suitably dimensioned so as to minimize the intrusion of the paper clip 2 over the paper when compared to prior art paper clips 62 as shown in FIG. 6.

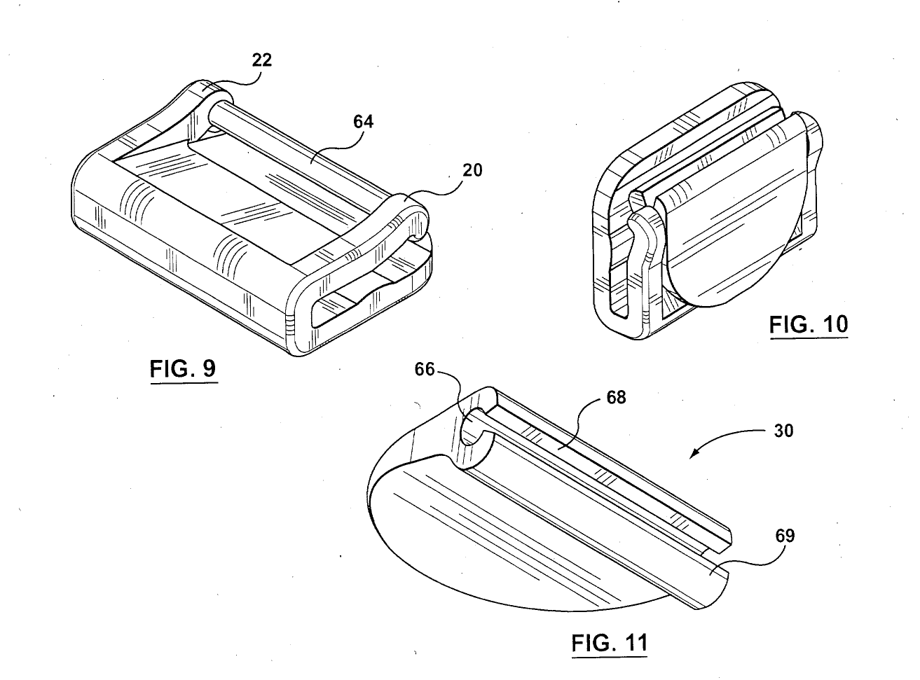

FIGS. 9, 10 and 11 illustrate another embodiment of the invention which includes, a rod 64 which extends from and between the arms 20 and 22. The cam member 30 includes a slot 66 which is adapted to accommodate and receive the rod 64 to permit pivotal movement of the cam member 30 about the rod 64. The slot 66 is dimensioned to receive the rod 64. As previously mentioned the cam member 30 can comprise of flexible material such as plastic whereby the edges 68 and 69 of the slot 66 deform and accommodate the insertion of the rod 64. The assembled view of a second embodiment of the invention is shown in FIG. 10.

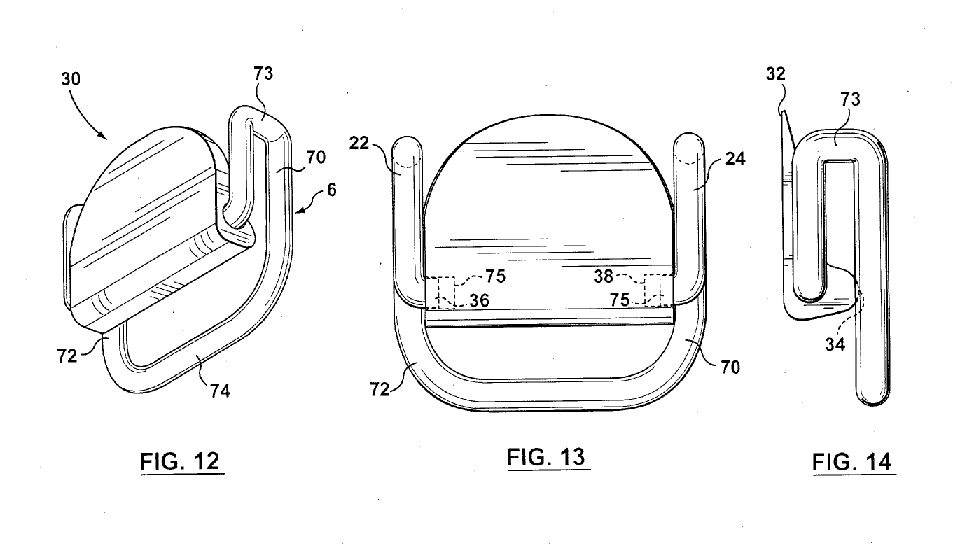

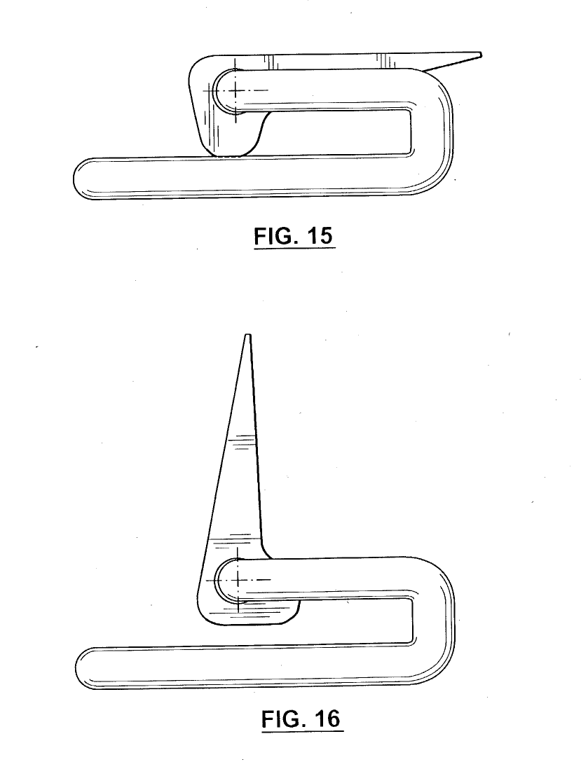

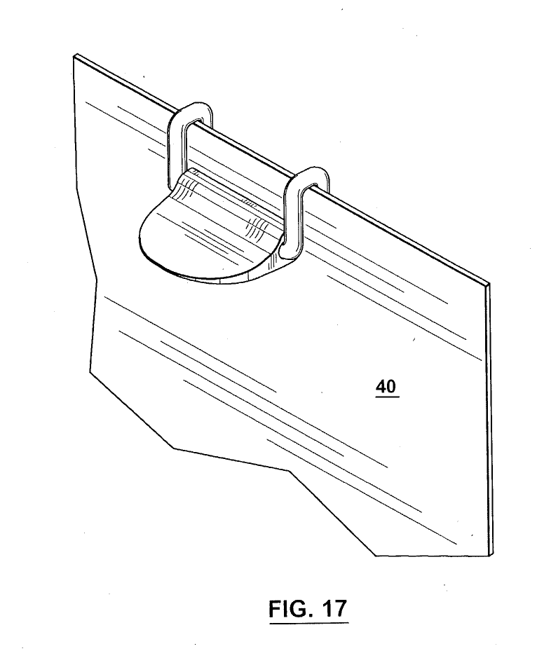

FIGS. 12-17 inclusive illustrate a third embodiment of the invention which also comprises a base 6 and cam member 30.

The base 6 comprises two spaced leg member 70 and 72 joined together by a connecting member 74. Each leg member 70 and 72 presents an arm member 22 and 24 respectively as shown in FIGS. 11 and 12. The arm members 22 and 24 are spaced from the leg members 70 and 72 respectively by a spacing member 73. Each of the leg members 70, 72, connecting member 74, arms 22 and 24 and spacing member 73 are circular in cross-section. The arm members 22 and 24 are presented by the leg members 72 and 70 in the region remote from the connecting member 74. The end 75 of the arm members 22 and 24 are turned inwardly and are adapted to be received by the holes 36 and 38 of the cam member 30.

The embodiment shown in FIGS. 12-17 can comprise of any suitable material such as plastic or the like or alternatively the legs 70 and 72, connecting member 74, spacing member 73 and arms 22 and 24 can be made from wire or metal which is easily bent. The arms 22 and 24 may be bent away from one another so as to place the cam member 30 therebetween for registration of the ends 75 with the holes 36 and 38 of the cam member 30.

The cam member 30 can be dimensioned so as to present a cammed surface 34 which extends slightly beyond the legs 70 and 72 in the closed position as best seen in FIG. 14 so as to assist in the clamping action of the paper inserted between the arms 22 and 24 and legs 70 and 72.

FIG. 14 shows that the arms 22 and 24 and legs 70 and 72 are substantially parallel although it is also possible to have the ends 75 of the arms 22 and 24 tapered slightly inwardly towards the legs 70 and 72 in the vicinity away from connecting member 73 so as to assist in the “pinching” or “gripping” action of the cam surface 34 relative the legs 70 and 72.

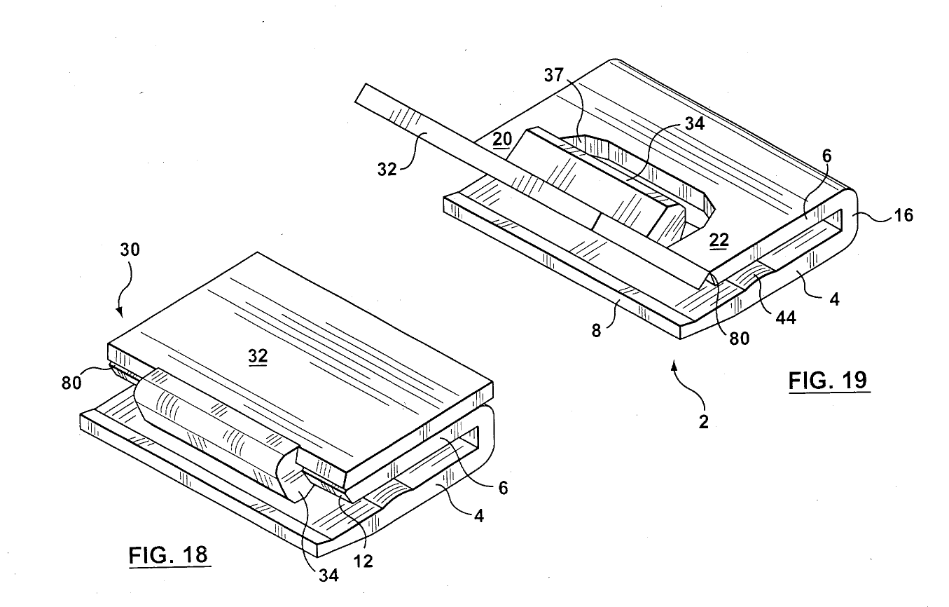

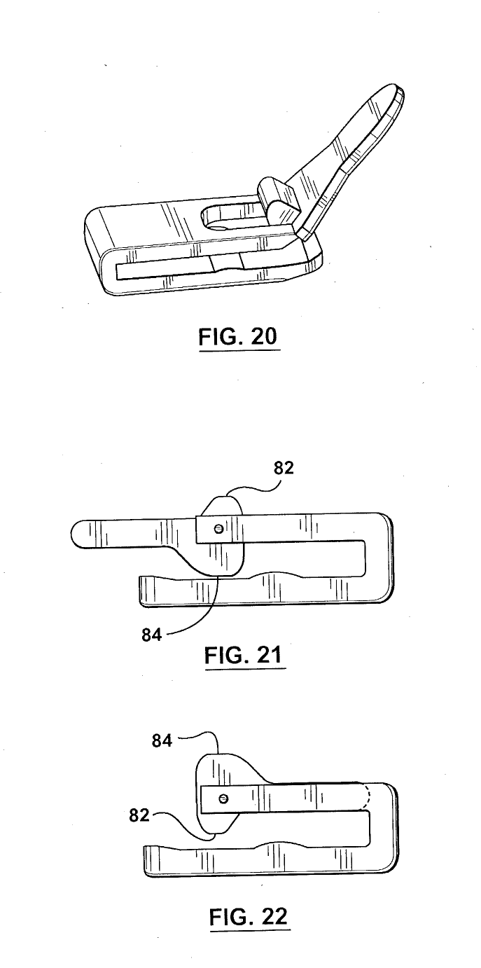

Another embodiment of the invention is illustrated in FIGS. 18, 19 and 20 which illustrates a one-piece paper clip 2. By way of example a suitable material for the paper clip comprises plastic. In particular the cam member 30 is integrally connected to the front edge 12 of the second member 6 by a reduction 80 in the thickness of the plastic material between the front edge 12 of the upper surface 6 and the cam member 30. The reduction 80 defines a web which permits the rotational movement of the cam member 30 from the closed position shown in FIG. 18 about the web 80 to the open position shown in FIG. 19.

The paper clip 2 can be extruded or molded in an appropriate machine. Since the plastic will tend to have a memory of the part in an open position the cam surface 34 can be suitably dimensioned relative the base 4 so as permit closure of the paper clip 30 to the closed position.

As can be best seen from FIG. 18 the second surface 6 can include a hole 37 to receive the cam 34 as the cam member 30 is swung from the closed position to the open position as shown.

The one-piece clip 2 is easy to manufacture and eliminates the need to assemble the cam member 30 to the arms 20 and 22.

Another embodiment of the invention is shown in FIGS. 21 and 22 which illustrates that the cam member 30 can include a first cam surface 82 at one end thereof operably movable to a first closed position to close a first thickness of the paper 40 to clamp the first thickness of the paper 40 between the first cam surface 82 and the first surface or base 6. Furthermore the cam member 30 can also include a second cam surface 84 pivotally movable to a second closed position to clamp a second thickness of paper between the second cam surface 84 and the first surface or base 6. This way one paper clip 2 can accommodate two different thicknesses of stacked paper to be clipped therebetween.

Accordingly the paper clip 2 described herein can be used for clamping paper by:

(a) moving the tab 32 to a first opened position where the cam surface 34 is displaced away from the first surface or base 6;

(b) inserting the paper through the forward edges 8 and 12 between the opposed surfaces 4 and 6;

(c) moving the tab 32 to a closed position where the cam surface 34 is displaced or rotated toward the second or base surface 6 to clamp the paper 40 between the cam surface 34 and the first surface or base 6.

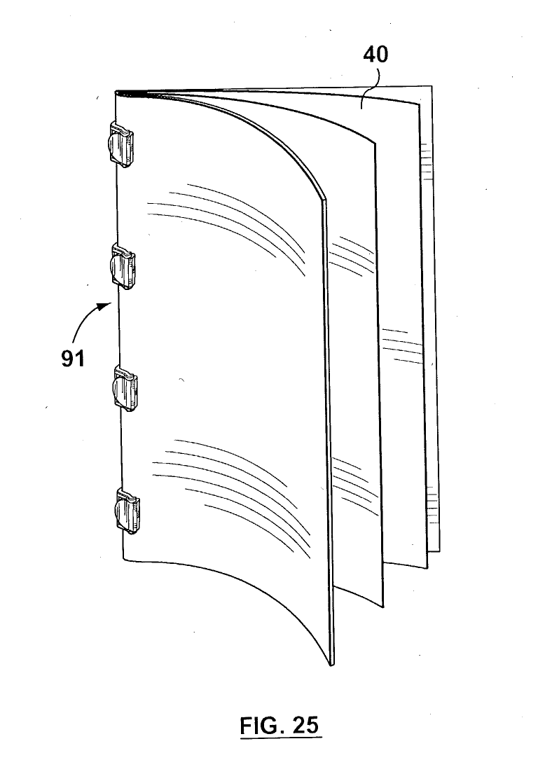

Furthermore as shown in FIG. 25 a plurality of paper clips 2 can be clipped along one edge 91 of the paper 40 to permit the paper to be separately moved about the one edge 91 of the paper much like a book since the paper clip 2 will not intrude significantly into the text of the paper. Alternatively the clip 2 can be combined or connected as shown so as to present a paper binder.

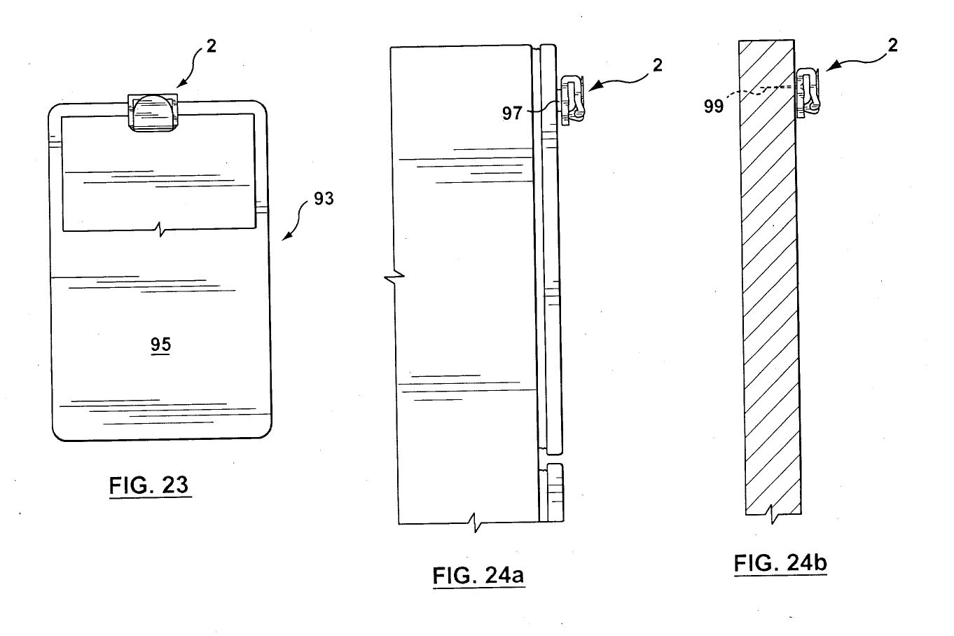

Moreover FIG. 23 illustrates that a clipboard 93 can be fashioned with the clip 2 secured to a board 95 to define a clipboard 93. Either one or more clips 2 may be secured near the top of the board 95.

FIG. 24a shows the base 4 having a magnetic material 97 for use as a fridge magnet and FIG. 24b shows the pin type paper clip 2 having a base 4 presenting a pin 99 where the paper clip holds paper that can be pinned to a message board.

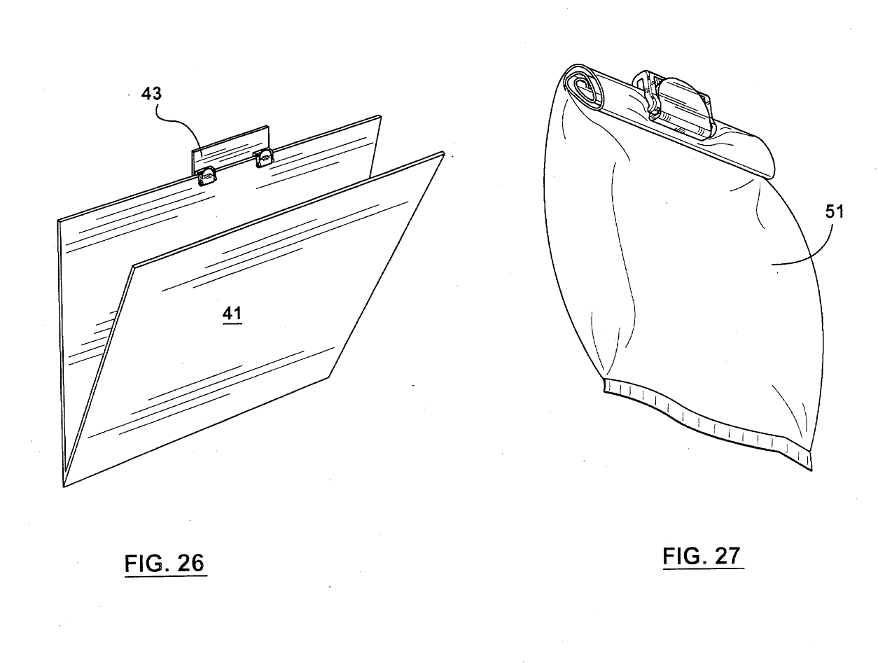

FIG. 26 illustrates another embodiment of the invention where the base 4 includes a extension or file tab 43. The clip 2 can be attached to an office file and act as a marker. Two small spaced clips are shown in FIG. 26. The file tab 43 is adapted to receive indicia such as a sticky label to be written on, or alternatively the file tab can comprise a material to be written on. Once the office file is stored in a filing cabinet the file tab will stick out to mark its location.

FIG. 27 shows the use of the clip 2 in closing the open bag, such as a potato chip bag 51.

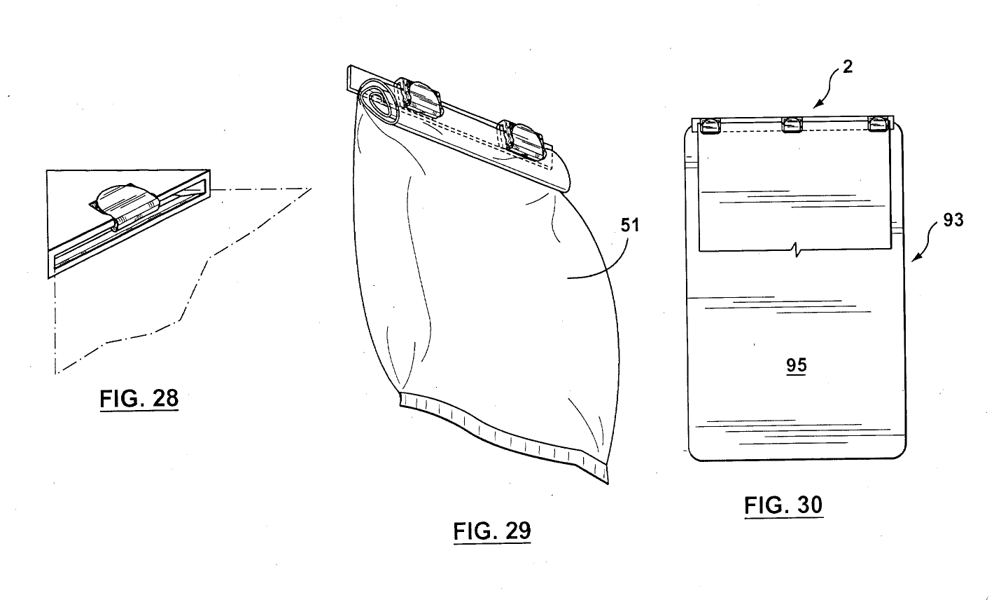

FIG. 28 illustrates the clip 2 adapted to clip the corner of a stack of paper.

FIG. 29 illustrates a plurality of clips 2 carried by a frame to attach either one article thereto or a plurality of articles respectively.

FIG. 30 illustrates a clipboard which has the clip 2 described herein attached thereto to hold paper to the clipboard.

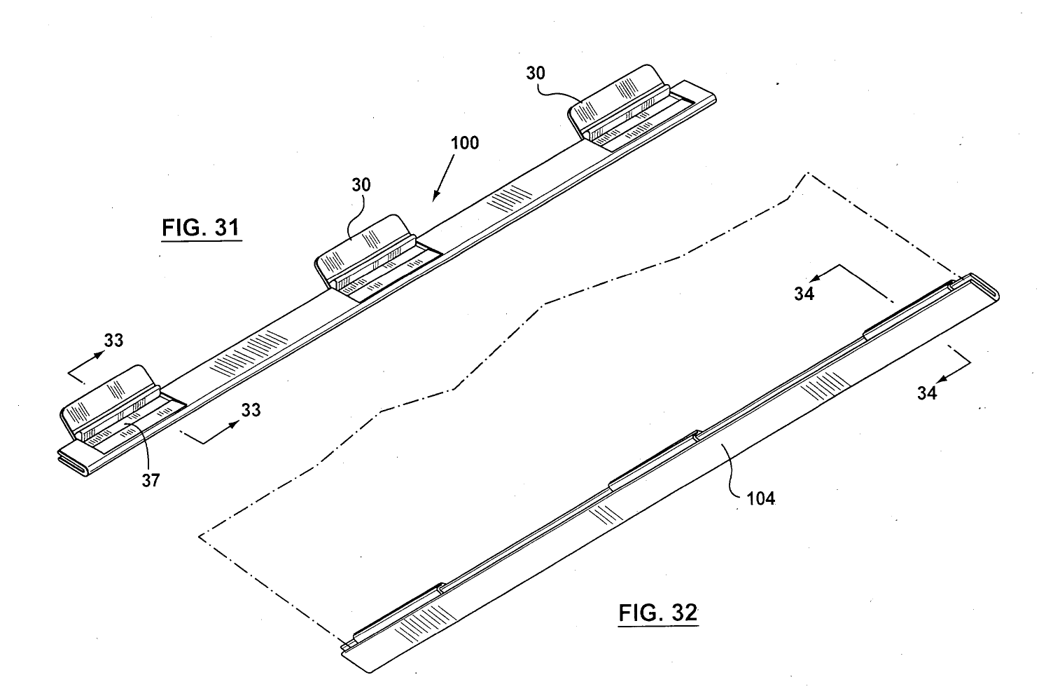

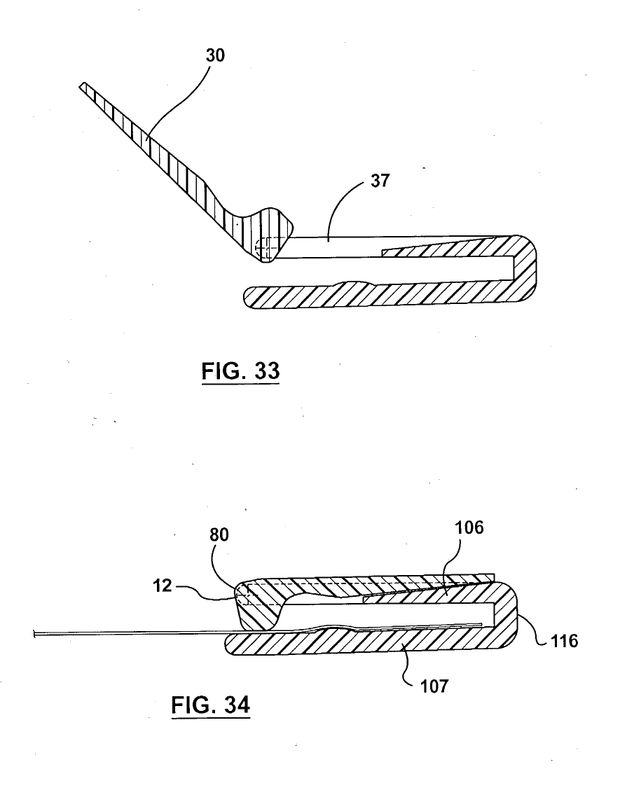

Another embodiment of the invention is illustrated in FIGS. 31 to 34 inclusive which consists of a plurality of clips 2 which define a paper binder 100 having a first opposed or base strip 104 which extends upwardly through the connecting extension 116 and merge with the second strip 106. Each cam member 30 is integrally connected to the front edge 12 of the second strip 106 by a reduction 80 which defines a web which permits the rotational movements of the cam members from the closed position shown in FIG. 34 to the open position shown in FIG. 33. The second strip has a plurality of holes 37 to receive the cams 30. Alternatively the cam members can be adapted to rotate about the pins as described above. The bookbinder is adapted to removably receive a stack of pages.

The paper clip described herein has the following perceived advantages:

1. a higher perceived value than prior art paper clips that may be less likely to the thrown out with the papers;

2. the camming action makes the paper clip 2 reusable many more times than a prior art paper clip whose spring action decreases with use. Such reusability may save cost in the long run as well as the time to reorder same;

3. the paper clips described herein can include messages on the tab as herein described;

4. moreover the paper clips having a better clamping or gripping force and can be used instead of staples;

5. furthermore the paper clip described herein can be dimensioned so as to cover the corners of the paper to make them more attractive and appealable in a finished presentation;

6. a larger version of the paper clip described can replace large metal paper clips that can scratch desks and boardroom tables;

7. there is less likelihood of tangling up stray paper with the clipped papers;

8. metal paper clips rust if-left on documents and stored for long periods of time whereas plastic paper clips described herein will not;

9. two-sided cam designs as described above replace different sized prior art paper clips;

10. paper clips described herein can be used to present papers in a booklet format;

11. even one paper clip as described herein makes flipping through and reading the pages easier than using a prior art wire bent paper clip at the top of the pages;

12. oblong metal paper clips are often twisted out of shape and used as projectiles propelled by elastic bands. The paper clip described herein is safer with less likelihood of causing the same damage if propelled.

Various embodiments of the invention have now been described in detail. Since changes in and/or additions to the above-described best mode may be made without departing from the nature, spirit or scope of the invention, the invention is not to be limited to said details.

We claim:

1. A clip for securing sheet material comprising:
(a) a base;
(b) a cam member operably connected to said base for displaceable movement between
(i) an open position for insertion of said sheet material between said base and said cam member;
(ii) a closed position for gripping said sheet material between said base and said cam.

2. A clip as claimed in claim 1 wherein said base extends outwardly from one edge thereof to present an arm wherein said cam member is rotatably connected to said arm for movement between said open and closed positions.

3. A clip as claimed in claim 1 wherein said base comprises a flat member presenting two spaced arms extending outwardly from one edge of said base, and wherein said cam member is pivotally connected to and between said spaced arms for pivotable movement between said open and closed positions.

4. A clip as claimed in claim 3 wherein each said arm includes a post and said cam member includes two spaced holes for receiving said posts respectively.

5. A clip as claimed in claim 3 wherein said arms including a rod extending between said arms and spaced from said base; and wherein said cam member includes a slot adapted to receive said rod for pivotal movement of said cam about said rod between said open and closed positions.

6. A clip as claimed in claim 1 wherein said base comprises two spaced leg members joined by a connecting member, each said leg member presenting an arm member extending from said leg members in the region remote from said connecting member, said members presenting a circular cross-section, and wherein said cam is pivotally connected to and between said spaced arm members for pivotal movement between said open and closed positions.

7. A clip as claimed in claim 1 wherein said cam member includes a tab operably movable at one end thereof and a cam at another end thereof.

8. A clip as claimed in claim 7 wherein said base presents an upstanding member at said one edge thereof merging with an opposing surface overlying said base, said opposing surface hingedly connected to said cam member for moving said cam member between said open and closed positions.

9. A clip as claimed in claim 8 wherein said base, upstanding member, opposing surface and cam member comprise of one piece plastic material, and said hinge connection comprises a reduction in thickness of said plastic material in the region between said cam member and said opposing surface remote from said upstanding member.

10. A clip as claimed in claim 9 wherein said opposing surface includes an opening for receiving said cam when said tab is operably movable from said open to said closed position.

11. A paper clip for securing paper comprising:
(a) first and second opposed surfaces, each having a forward and rear edge, and connected together at said rear edge, to permit insertion of said paper through said front edge between said first and second surfaces;
(b) a cam member pivotally connected to said front edge of said second surface for displaceable movement between:
(i) an open position where said cam member is displaced away from said first surface to permit insertion of said paper between said first and second surfaces, and
(ii) a closed position where said cam member is displaced towards said first member to clamp said paper between said cam member and said second surface.

12. A paper clip as claimed in claim 11 wherein said second surface is substantially flat and includes an upturned forward edge presented by said first member to inhibit the accidental insertion of paper between said first and second surfaces in said closed position, and to deflect paper away from said paper clip in said closed position.

13. A paper clip as claimed in claim 12 wherein said first surface includes a raised portion between said front and rear edge to bend and assist trapping said paper in said closed position.

14. A paper clip as claimed in claim 11 wherein said cam member includes an operably movable tab at one end thereof and a cam surface at another end thereof.

15. A paper clip as claimed in claim 11 wherein said cam member includes an operably movable tab at one end thereof and
(i) a first cam surface at another end thereof operably movable to a first closed position to clamp a first thickness of paper between said first cam surface and said first surface;
(ii) a second cam surface at another end thereof operably movable to a second closed position to clamp a second thickness of paper between said second cam surface and said first surface.

16. A paper clip as claimed in claim 11 wherein said second surface includes a recess for receiving said tab in said closed position, and said tab extends beyond said rear edge of said second surface in said closed position.

17. A paper clip as claimed in claim 11 wherein said second surface includes posts and said cam member includes holes for receiving said posts for pivotal movement thereabout.

18. A paper clip as claimed in claim 11 wherein said cam member is integrally connected to said front edge of said second member for rotational movement thereabout.

19. A method of clamping paper in a paper clip having spaced first and second opposed surfaces, each first and second opposed surface having a forward and rear edge, and connected together at said rear edge, and a cam member having a tab at one end thereof and a cam surface at another end thereof comprising the steps of:
(a) moving said tab to a first open position where said cam surface is displaced away from said first surface;
(b) inserting paper through said forward edge between the said first and second opposed surfaces;
(c) moving said tab to a closed position whereby said cam surface is displaced towards said first surface to clamp said paper between said cam surface and said second opposed surface.

20. A method as claimed in claim 19 wherein said paper is clamped by a desired number of said paper clips defining a binder along one edge of said paper to permit said paper to be separately moved about said one edge of said paper.
